(19) United States
(12) Patent Application Publication
(10) Pub. No.: US 2022/0083979 A1
(43) Pub. Date: Mar. 17, 2022

(54) SYSTEMS AND METHODS FOR DATABASE MANAGEMENT AND GRAPHICAL USER INTERFACE DISPLAYS

(71) Applicant: Capital One Services, LLC, McLean, VA (US)

(72) Inventors: Latika GULATI, Vienna, VA (US); Michael MOSSOBA, Arlington, VA (US); Abdelkader BENKREIRA, Washington, DC (US)

(21) Appl. No.: 17/024,331

(22) Filed: Sep. 17, 2020

(51) Int. Cl. G06Q 10/10; G06Q 30/02; G06Q 50/12; G06N 20/00; G06F 16/9536

(52) U.S. Cl. CPC G06Q 10/1053; G06Q 30/0282; G06F 16/9536; G06N 20/00; G06Q 50/12

(57) ABSTRACT

A browser extension can be configured to determine that the internet browser is presenting a website that includes a job posting, determine a restaurant name in the job posting, match the restaurant name to an indexed restaurant in a tip data table, and display the tip data for the indexed restaurant to the user. The tip data can be displayed as a number of one to five dollar signs. A database can store the tip data table that is indexed by restaurant and has tip data for each indexed restaurant. The server can be configured to provide a tip data analysis engine that uses a machine learning model to analyze the tip data associated with one or more indexed restaurants in the database based on the restaurant name.

### FIELD OF THE INVENTION

The present disclosure generally relates to database management and graphical user interface displays and, in particular, to systems and methods for tracking tips paid to restaurant workers, calculating tips, storing tip data, and displaying tip data in various ways such as on job posting websites.

### BACKGROUND

A large number of people work in restaurants as servers, bartenders, and other service workers and they rely on tips for part of their income. A person looking for a job in a restaurant online may not always have a clear picture of their expected compensation given the variability of tip income. A job posting typically has an hourly rate but no tip data. There is a lot of ambiguity as far as what the total compensation might be for a position. The job seeker may check menus to get a sense of how much people are spending on a meal or check out the restaurant to see how busy it is. A job seeker may try to talk with people at the restaurant to figure out how much they make in a typical shift.

Some restaurants have been accused of wage theft. While wage theft might conjure images of employers withholding checks or skimming hours from the workers' timesheets, the most-used methods are far less obvious and often hard to detect. For example, several restaurants have settled claims of unpaid wages, often centering on overtime and tips. Wage theft sometimes happens in the restaurant industry, from fast food to fine dining. Though some cities and states have taken steps to protect workers, the problem persists. Restaurant workers earn a significant part of their income via tips. Employers can pay tipped workers less so long as their tips bring them up to a minimum wage. This makes tipped workers vulnerable for wage theft.

Accordingly, there is a need to make tip data available to people looking for restaurant jobs and, once tip data is available, there will be a way to help protect service workers from tip theft by restaurant management.

### SUMMARY

The disclosed subject matter is directed to systems and methods for database management, artificial intelligence (AI) modeling and graphical user interface displays of tip data that satisfy these needs.

An example embodiment of the present disclosure can be a system, comprising: a merchant matching interface that is configured to receive website information from a browser extension, determine whether the received website information identifies a merchant, identify an indexed merchant in a database based on the determination that the received website information identifies a merchant, and use other website information to identify one or more indexed merchants based on a determination that the received web site information does not identify a merchant; and a tip data analysis engine that is configured to use a machine learning model to analyze the tip data associated with one or more indexed merchants in the database based on the received identification information, wherein: the browser extension is configured to examine contents of a web site and determine that the internet browser is presenting a web site that includes a job posting, the browser extension is configured to extract the website information and transmit the website information to the merchant matching interface, and the browser extension is configured to receive tip data from the tip data analysis engine and display the tip data to a user via the internet browser.

An example embodiment of the present disclosure can be a method, comprising: reading, using a browser extension, internet website content associated with an internet web site; determining, using the browser extension and the read web site content, that the internet website includes a job posting; extracting, using the browser extension, merchant information from the read website content; transmitting, via a network, merchant information to a tip data analysis engine; receiving, via the network, tip data from the tip data analysis engine; and displaying, via a graphical user interface and using the browser extension, the received tip data, wherein a merchant matching interface is configured to: receive the merchant information from the browser extension, determine whether the received website information identifies a merchant, identify an indexed merchant in a database based on the determination that the received website information identifies a merchant, and use other merchant information to identify one or more indexed merchants based on a determination that the received website information does not identify a merchant, and wherein the tip data analysis engine is configured to use a machine learning model to analyze the tip data associated with one or more indexed merchants in the database based on the received identification information.

An example embodiment of the present disclosure can be non-transitory computer-accessible medium having stored thereon computer-executable instructions, wherein upon execution by a computer arrangement comprising a processor, the instructions cause the computer arrangement to perform procedures, comprising: providing a restaurant matching interface that is configured to receive website information from a browser extension, determine whether the received website information identifies a restaurant, identify an indexed restaurant in a database based on the determination that the received website information identifies a restaurant, and use other website information to identify one or more indexed restaurant based on a determination that the received website information does not identify a restaurant; and providing a tip data analysis engine that is configured to use a machine learning model to analyze the tip data associated with one or more indexed restaurants in the database based on the received identification information.

These and other features, aspects and advantages of the disclosed subject matter are explained in greater detail with reference to specific example embodiments that are illustrated in the following description, appended claims, and accompanying drawings.

### BRIEF DESCRIPTION OF THE DRAWINGS

FIG. 1 is a diagram of a system according to an example embodiment of the disclosure.

FIG. 2 is a flow chart of a method according to an example embodiment of the disclosure.

FIG. 3 is a flow chart of a method according to an example embodiment of the disclosure.

FIG. 4 is a diagram of a computer-accessible medium according to an example embodiment of the disclosure.

FIG. 5 is a diagram of a system according to an example embodiment of the disclosure.

FIG. 6 is a diagram of a system according to an example embodiment of the disclosure.

FIG. 7 is a diagram of a method showing example interactions between system components according to an example embodiment of the disclosure.

FIG. 8 is a flow chart of a method according to an example embodiment of the disclosure.

FIG. 9 is a flow chart of a method according to an example embodiment of the disclosure.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

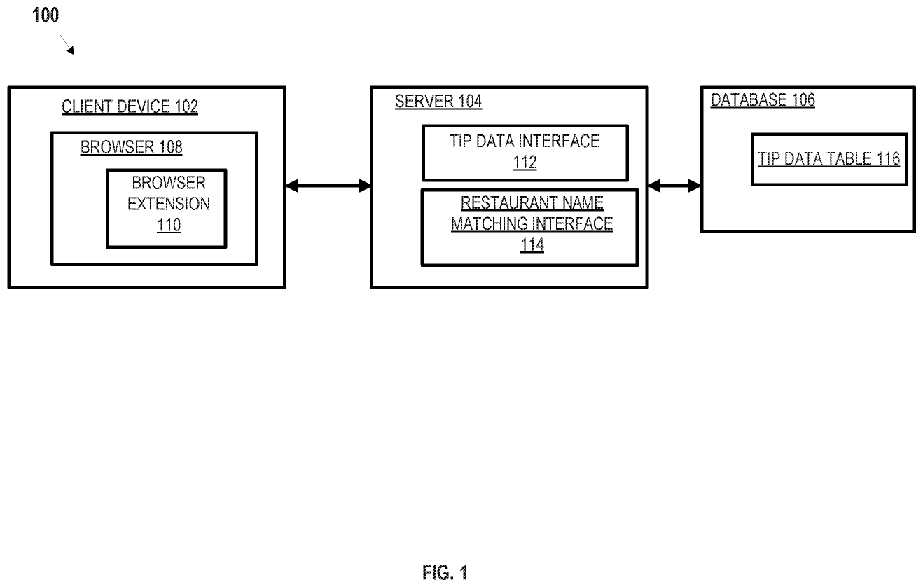

FIG. 1 is diagram of a system 100 according to an example embodiment of the disclosure. System 100 can include a client device 102, a server 104 and a database 106. Client device 102 and server 104 can be network-enabled computers in data communication with each other. Server 104 can be in data communication with database 106.

As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, a mobile device, a smartcard, or other device. For example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

In system 100, a network-enabled computer such as server 104 can include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein.

In system 100, a network-enabled computer such as client device 102 can include a display and input devices. The display can be any type of device for presenting visual information such as a computer monitor, a flat panel display, and a mobile device screen, including liquid crystal displays, light-emitting diode displays, plasma panels, and cathode ray tube displays. The input devices can include any device for entering information into the user's device that is available and supported by the user's device, such as a touch-screen, keyboard, mouse, cursor-control device, touch-screen, microphone, digital camera, video recorder or camcorder. These devices can be used to enter information and interact with the software and other devices described herein. In some examples, the network-enabled computer can execute one or more applications, such as software applications, that enable, for example, network communications with one or more components of the system 100 and transmit and/or receive data.

In system 100, a network-enabled computer can be client device 102 in communication with one or more servers 104 via one or more networks, and can operate as a respective front-end to back-end pair with server 104. Client device 102 can transmit, for example from a mobile device application executing on client device 102, one or more requests to server 104. The one or more requests can be associated with retrieving data from server 104. Server 104 can receive the one or more requests from client device 102. Based on the one or more requests from client device 102, server 104 can be configured to retrieve the requested data from one or more databases 106. Based on receipt of the requested data from the one or more databases 106, server 104 can be configured to transmit the received data to client device 102. For example, the received data can be responsive to one or more requests.

The network can be one or more of a wireless network, a wired network or any combination of wireless network and wired network, and can be configured to connect the client device to the server. For example, the network can include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

The network can include, without limitation, telephone lines, fiber optics, IEEE Ethernet 902.3, a wide area network, a wireless personal area network, a LAN, or a global network such as the Internet. The network can support an Internet network, a wireless communication network, a cellular network, or the like, or any combination thereof. The network can further include one network, or any number of the exemplary types of networks mentioned above, operating as a stand-alone network or in cooperation with each other. The network can utilize one or more protocols of one or more network elements to which they are communicatively coupled. The network can translate to or from other protocols to one or more protocols of network devices. Although the network is depicted as a single network, it should be appreciated that according to one or more examples, the network can include any number of interconnected networks, such as, for example, the Internet, a service provider's network, a cable television network, corporate networks, such as credit card association networks, and home networks.

Database 106 can be any organized collection of data that is stored and accessed electronically from a network-enabled computer. Database 106 can include a database management system (DBMS), which is software that processes data for users such as defining, creating, maintaining, administering, and controlling access to the database. Database 106 can be a relational database that models data as rows and columns in tables and uses structured query language (SQL) for writing and querying data. Database 106 can be standalone on the network or combined with server 104 or another network-enabled computer.

In system 100, client device 102 can include a browser 108 having a browser extension 110. Browser 108 can be any interne or web browser such as Safari®, Chrome®, Spark®, Microsoft Edge®, Firefox®, or the like. Server 104 can include a tip data interface 112 and a restaurant name matching interface 114. Database 106 can include a tip data table 116.

Browser extension 110 can have an associated application programming interface (API) that, for example, enables browser extension 110 to access website data and user interface items. Browser extension 110 can be configured to determine that browser 108 is presenting a website that includes a job posting, determine a restaurant name in the job posting, match the restaurant name to an indexed restaurant in tip data table 116, and display the tip data for the indexed restaurant to the user. Browser extension 110 can be further configured to determine an employer in the job posting and determine whether the employer is a restaurant. Browser extension 110 can be further configured to read data from, for example, search fields within a website to identify keywords being input into search fields by the user.

Browser extension 110 can be programmed to detect when a user is on a job posting website such as Ihirehopsitality.com, Culinaryagents.com, LinkedIn.com, Ziprecruiter.com, Careerbuilder.com, Launch.com, Indeed.com, Restaurantjobs.com or the like. Browser extension 110 can determine whether the user is looking at a job posting that is relevant to the information stored in tip data table 116. Using natural language processing, for example, browser extension 110 can determine whether the job posting is for a restaurant job and what the name of the restaurant is. For example, browser extension can examine the contents of the website for key words such as waitress, server, restaurant, bartender and/or the like in combination with other indicators consistent with a job search engine to determine that a particular job posting is for a restaurant job. Once that determination is made, the name of the restaurant associated with the job posting may be determined and identified by browser extension 110.

Browser extension 110 can provide data to and interact with restaurant name matching interface 114 on server 104. Restaurant name matching interface can receive the identified and/or extracted name from a job posting website from browser extension 110. Restaurant name matching interface 114 can compare the name of the restaurant on the job posting with the restaurant names in tip data table 116 in database 106. Restaurant name matching interface 114 can use fuzzy matching to compare names. Restaurant name matching interface 114 can also use location information from the job posting such as city, state, zip code to match to a particular location for a restaurant that has multiple locations with the same name. The data stored in tip data table 116 can be searched for the matching name and then the associated tip data can be provided for display for the user on the job posting website on browser 108 on client device 102.

Server 104 can be configured to provide a tip data interface 112 to retrieve tip data associated with each indexed restaurant in database 106. Server 104 can be configured to provide a restaurant name matching interface 114 that retrieves the indexed restaurant in tip data table 116 matching the restaurant name in the job posting. Server 104 can be configured to receive updated tip data and to refresh tip data table 116. Server 104 can be further configured to refresh tip data table 116 using payment transactions. Database 106 can store payment transactions or payment transactions can be stored in another database.

Tip data interface 112 can infer tip data from the transactions from restaurants. For example, when server 104 processes a $50 pending, authorized transaction for service at a restaurant and then a few days later processes the posted transaction with a total amount that is increased from $50 to $60, then server 104 can infer a tip of $60−$50=$10. Server 104 can use tip data interface 112 to calculate the tip and store it with the restaurant name in tip data table 116 in database 106. Database 106 can store tip data table 116 that is indexed by restaurant and has tip data for each indexed restaurant. Server 104 can use tip data interface 112 to store other tip data sets such as daily tip data. For example, server 104 can run a daily batch job to update tip data sets and then periodically transfer the daily tip data sets to tip data table 116. The tip data from tip data table 116 can be transformed by server 104 and/or browser extension 110 to be in desirable and useful formats for display.

The tip data can be displayed visually on a website in browser 108 of client device 102 as a corresponding number of one to five dollar signs. The tip data can be displayed as a point in a range of tip values. The tip data can be displayed on a graph of tip values. The tip data can be displayed to reflect a tipping trend. The tip data can include a comparison to at least one other restaurant.

For example, browser 108 can display information indicating that the restaurant in the job posting makes 40% more in tips than all the other restaurants in a geographical area. For example, browser 108 can display a list of the top 10% best tipping restaurants in the area.

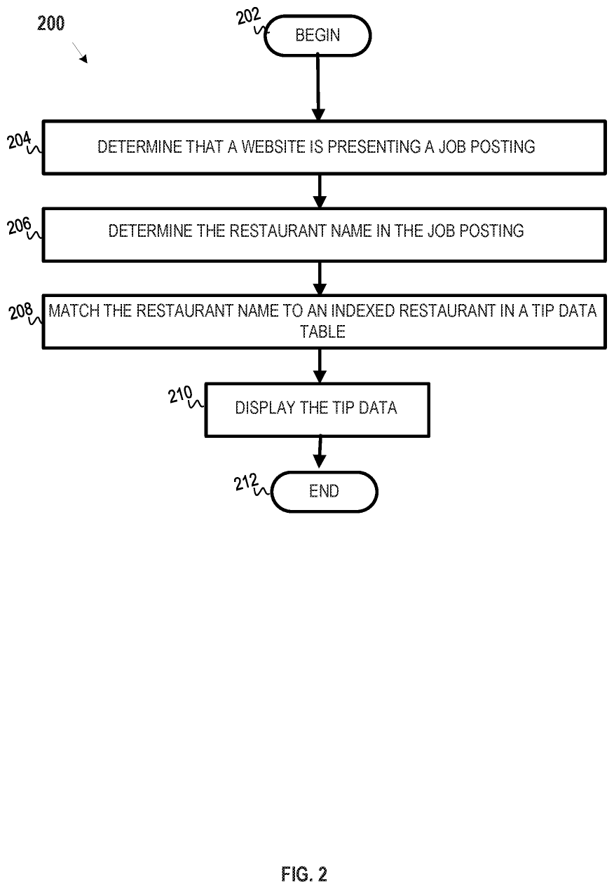

FIG. 2 is flow chart of a method 200 according to an example embodiment of the disclosure. The method 200 begins at block 202. At block 204, it can be determined that an internet browser is presenting a website that includes a job posting. For example, a browser extension can determine that the domain name of the website matches a list of known job posting websites. For example, the browser extension can extract text from the website and apply natural language processing to determine that the website includes a job posting. Where the browser extension examines the content of the website to determine if the website includes a job posting, the browser extension can, for example, examine the contents of the website for keywords to determine and/or infer that the website is a job posting website. For example, browser extension can examine the contents of the website for key words such as waitress, server, restaurant, bartender and/or the like in combination with other indicators consistent with a job search engine to determine that a particular job posting is for a restaurant job. Once that determination is made, the name of the restaurant associated with the job posting may be determined and identified the browser extension. The browser extension also may monitor keyword searches entered by the user by, for example, reading data from, search fields within a website to identify keywords being input into search fields by the user.

At block 206, it can be determined that a restaurant name is in the job posting. For example, an application can compare names in the job posting with known restaurant names from a database management program accessing and querying tip data stored in a database. For example, a browser extension can transmit names and other identifying information to be matched to restaurant names in a database to a backend server. For example, the backend server can store restaurant names for matching in a cache for quick access.

At block 208, the restaurant name can be matched to an indexed restaurant in a tip data table stored in a database. Restaurant names can be an index in the database schema for a tip data table in the database. For example, fuzzy logic can be used to match the restaurant name to the restaurant names in the database and common or known variants of the restaurant name. For example, location data can be used to match the restaurant name when it is a restaurant with many locations. To do so, a street address, zip code, and/or the like can be identified in the website, provided to the restaurant name matching interface and be compared to database entries to determine a match. Additional information associated with the restaurant name may be used to match the restaurant name to an indexed restaurant. For example, a phone number, store number and/or any other like unique information may be identified in the website, provided to the restaurant name matching interface and be compared to database entries to determine a match.

At block 210, the tip data for the indexed restaurant can be displayed to the user. The method 200 ends at block 212. There are many ways that the tip data can be displayed on a graphical user interface. For example, tip data can be displayed in text, pictorial, or graphical format. For example, tip data can be displayed using various data visualization tools and techniques such as charts, graphs, maps, colors, ordering, comparisons, dashboards, layout, hierarchy, word clouds and the like.

For example, a job seeker can obtain more information about total pay within the restaurant industry on a job posting website having tip data. The job posting website can show on average how much service workers are paid at certain restaurants. This can make it easier for job seekers to find a position that works best for them and ensure that they are getting adequate pay. Once the job seeker works at a restaurant, they can compare their earned tips with tip data for the restaurant on a website to catch tip theft by the restaurant management.

Method 200 can include database management programs that clean, organize, sort, and store additional tip data. For example, a restaurant can contribute tip data to be stored in the tip data table using an application programming interface for a restaurant enterprise program, a job posting application, or an industry standard library. For example, a restaurant worker can contribute tip data to be stored in the tip data table using an application programming interface for a restaurant application, a job posting application, or a government standard library. For example, other sources of tip data can be used for the tip data table. As explained in more detail below with respect to, for example, FIG. 1, a restaurant point of sale (PoS) system can receive and store tip data to be used in a tip data table.

Method 200 can be extended for additional businesses in the service industry beyond restaurants such as food delivery services and other services such as hair salons or cabs.

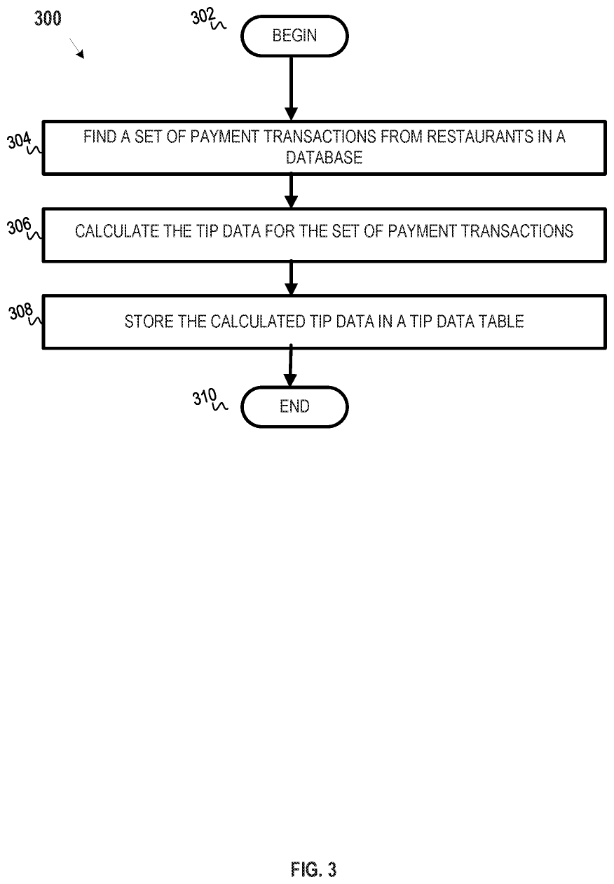

FIG. 3 is flow chart of a method 300 according to an example embodiment of the disclosure. The method 300 begins at block 302. At block 304, a set of payment transactions from restaurants can be identified in a database. For example, database management programs can run database queries, access, clean, sort, copy, and store tables related to payment transactions from restaurants and tip data. Payment transactions from a restaurant may be identified by restaurant name, location, transaction type, and/or unique information identifying a restaurant, such as a store number. In various examples, a backend server can run database programs periodically to refresh and store tip data for quick access by a browser extension and to ensure accuracy and timeliness.

At block 306, tip data can be calculated for the set of payment transactions. For example, tips can be calculated by subtracting an initial authorized service charge from a later final total charge. Tips can be calculated by a backend server and stored in tables indexed by restaurant name in a database. Tip data can be provided by the backend server to a browser extension on a job posting website.

At block 308, the calculated tip data can be stored in the tip data table. The method 300 ends at block 310. For example, the backend server can calculate and store the tip data in the tip data table. For example, tip data can be stored in multiple tip data tables with various schemas, indexes, access programs, and stored queries. Tip data can be stored as individual transaction tip amounts, which then can be used to calculate additional tip data that also can be stored in the tip database. For example, individual tip transaction amounts can be used to calculate a tip average that can then be compared to other tip averages for similar restaurants as explained in more detail below.

The method 300 can include cleaning the transaction data to compensate for issues such as name changes. Data cleansing can be performed on the payment transactions. A list of indexed restaurants can be created from the set of payment transactions. The indexed restaurants can be stored on the list of indexed restaurants in the tip data table with the associated calculated tip data. The tip data table can be refreshed using additional payment transactions.

For example, a transaction can have a restaurant name of “Joe's Restaurant” but the restaurant is officially called “Joe's LLC” and the restaurant has a sign saying “Pirate Bar”. A merchant can fill in any name on an application for credit card transaction processing. Sometimes, merchants rebrand, change owners or change names and fail to notify credit card transaction processing companies.

The method 300 can gather tip data from the set of payment transactions and make the tip data available to people seeking restaurant jobs online. For example, method 300 can include a whitelist of job boards such as Ihirehopsitality.com, Culinaryagents.com, LinkedIn.com, Ziprecruiter.com, Careerbuilder.com, Launch.com, Indeed.com, Restaurantjobs.com or the like. When the user is browsing one of the websites in the whitelist, then browser listening, monitoring, web extraction techniques, or screen scraping can be performed. A program can be run every time a website refreshes to determine a restaurant name exists in the job posting and other information such as location. For example, a user on monster.com can be looking at a job posting for a restaurant server at Tenaya Lodge in Yosemite. The program can extract the restaurant name and location and check if there is tip data for that restaurant to display. The tip data table can include synthesized data from cleansed transactions. The tip data from the tip data table can be transformed into various formats for display on the website such as dollar signs and indications of shifts. For example, tip data can be displayed with 1-3 dollar signs for a lunch shift, 3-4 dollar signs for an evening shift, and seasonal trends for Yosemite. For example, tip data can show a curve and where the job posting at Tenaya Lodge in Yosemite falls on the curve of restaurants in nearby locations. For example, the display can include suggestions of similar jobs with similar or better tip data. For example, job posting websites can use an application programming interface to access tip data.

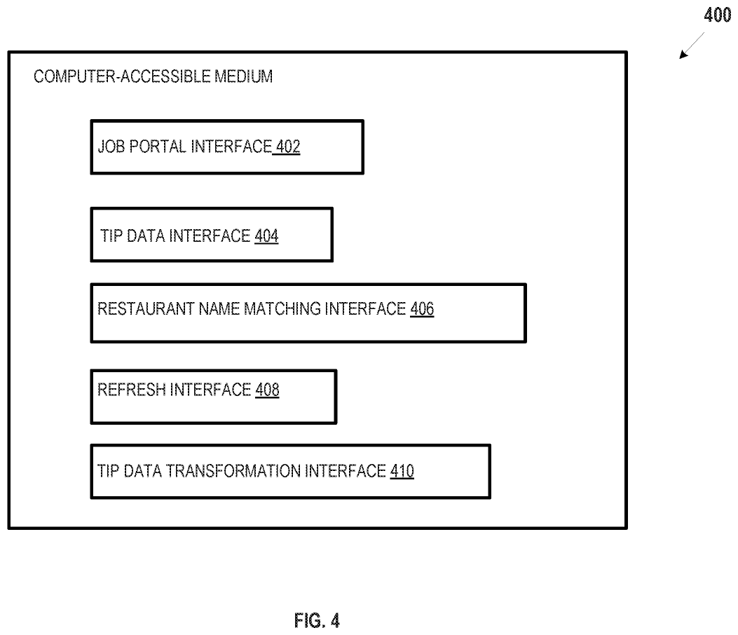

FIG. 4 is diagram of a computer readable medium 400 according to an example embodiment of the disclosure. The computer readable medium 400 can be a non-transitory computer-accessible medium that stores computer-executable instructions. When executed by a computer having a processor, the instructions can cause the computer to perform procedures. In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the client devices 102 and/or server 104 or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

For example, the procedures can include providing a job portal interface 402, providing a tip data interface 404, providing a restaurant name matching interface 406, and providing a refresh interface 408.

Job portal interface 402 can match a restaurant name in a job posting to an indexed restaurant in a tip data table and provide tip data for the indexed restaurant. For example, fuzzy logic can be used to match the restaurant name. For example, database management matching programs can use a list of known variants of known restaurants in the tip data stored in the database. For example, database management queries can use various matching techniques such as wildcards. For example, location can be used to match restaurant names with multiple locations. Job portal interface 402 can examine the contents of the website to determine the restaurant associated with the job posting. Job portal interface 402 also may examine the contents of keyword searches input by the user to determine a restaurant name.

Tip data interface 404 can retrieve tip data associated with an indexed restaurant name in a database. For example, database management programs can access the tip data in the database using a schema and index including the restaurant name. For example, a database management program can include a query to find all the tip data records for a restaurant in a table in the database.

Restaurant name matching interface 406 can retrieve the indexed restaurant in the tip data table matching the restaurant name in the job posting. For example, a restaurant having various matching names can use one of those names as the index into a table in the database. For example, a database management program can match a restaurant name to those restaurant names that are used as indexes into the table and then run a query using the indexed restaurant name to retrieve the tip data for that restaurant.

Refresh interface 408 can update the tip data table with updated tip data. For example, as service transactions are authorized and finalized at a backend server for a restaurant, database management programs can calculate tip data and refresh the tip data in the tip data table periodically. For example, a timestamp in transactions can be used to determine the reliability of data and indicate how and when to refresh it as new transactions come in.

The procedures can further include providing a tip data transformation interface 410 that displays the tip data as a number of one to five dollar signs. The procedures can further include providing a tip data transformation interface 410 that displays the tip data as a point in a range of tip values. The procedures can further include providing a tip data transformation interface 410 that displays the tip data on a graph of tip values. The procedures can further include providing a tip data trend interface that displays tipping trends. The procedures can further include providing a tip data transformation interface 410 that compares the tip data to at least one other restaurant. These comparisons may be based on restaurant location and/or proximity to the restaurant identified in the job posting, restaurant type (e.g., fast casual, upscale fine dining, pizza parlor, etc.), or the like. Refresh interface 408 can refresh the tip data table using payment transactions.

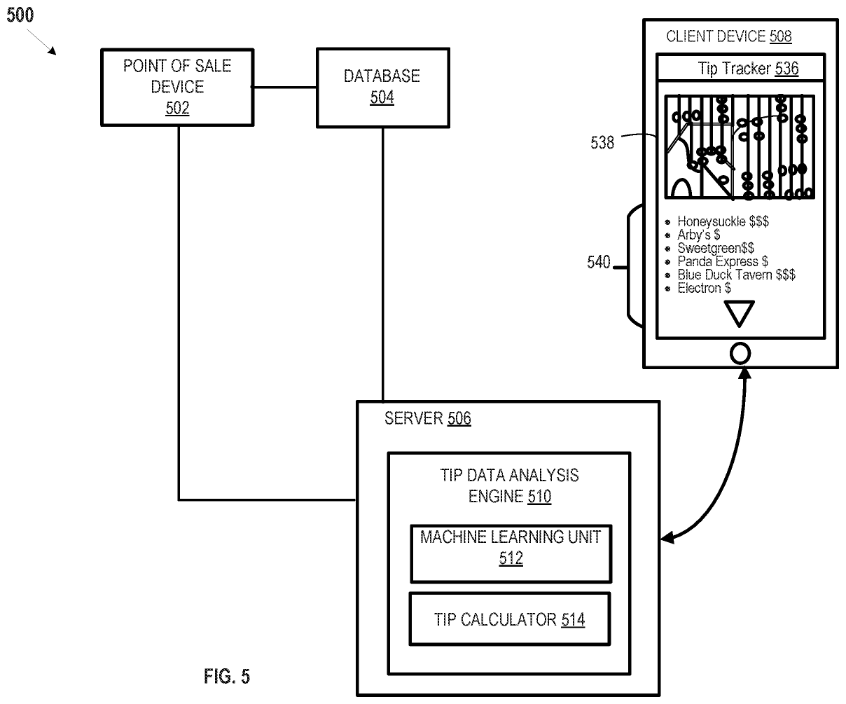

FIG. 5 is diagram of a system 500 according to an example embodiment of the disclosure. System 500 can include a point-of-sale device 502, a database 504, a server 506, and a client device 508. Point of sale device 502, database 504, server 506, and client device 508 can be network-enabled computers that are in data communication with each other on a network.

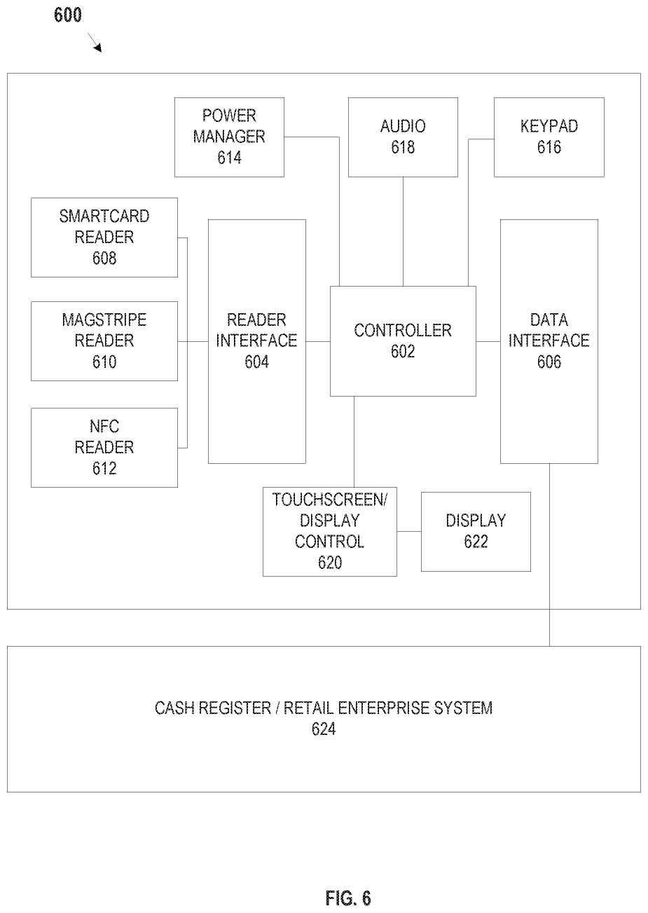

For example, a customer having a meal in a restaurant can be given a receipt with the service price of $10. The customer can give their credit card to the cashier and the cashier can swipe the credit card for the $10 service price. Point of sale device 502, which may be a point of sale device similar to the point of sale device as shown and described in FIG. 6, can transmit the initial amount of $10 to server 506 and server 506 can post the pending transaction to the customer's account. Once the credit card is authenticated, a second receipt can be given to the customer with the option to add a tip. The customer can add a tip of $2 and sign the second receipt. Point of sale device 502 can adjust the amount paid to account for the tip (i.e., $10+$2=$12) and authenticate the total amount 520. Point of sale device 502 and/or server 506 can store the initial amount of $10 and the total amount of $12 in the database 504. Server 506 can be notified by point of sale device 502 of the change in amount or can access the transactions in database 504 to determine the change in amount. Server 506 can charge the customer account for the total amount (i.e., service plus tip). Server 506 can calculate the difference between the initial amount and the total amount to find the tip amount (i.e., $12−$10=−$2).

Server 506 may include a tip data analysis engine 510, machine learning unit 512, and tip calculator 514. Server 506 can access database 504 to find transactions involving restaurants and tips. For example, server 506 can find four transactions having the same restaurant name. The first transaction can include an initial amount of $22, a total amount of $25, and tip of $3. The second transaction can include an initial amount of $20, a total amount of $30, and a tip of $10. The third transaction can include an initial amount of $10, a total amount of $12, and a tip of $2. The fourth transaction can include an initial amount of $4, a total amount of $5, and a tip of $1. Using, for example, tip calculator 514, server 506 can process these four transactions found in the database for the same restaurant, and, for example, calculate the tip amount, calculate an average tip, and transform the tip data for display on client device 508. Server 506 can process sets of transactions for other restaurants in a similar way. Server 506 can store processed tip data in database 504, local memory, a cache, or another storage device on the network for quick access and display on client device 508.

Tip data analysis engine 510 also may analyze transactions using machine learning unit 512 as shown and described herein. For example, where a browser extension has determined that a user is visiting indeed.com, indeed.com is on the whitelist, and the job posting is for Outback Steakhouse store number 12345, tip data analysis engine 510 may analyze the transaction data associated with Outback Steakhouse store number 12345 using artificial intelligence machine learning to predict that the tips for the next six months will average 20 dollars/per table. This analysis may include the average tips based on the transaction data herein. The analysis also may include, for example, understanding that the particular Outback Steakhouse is located in an area that experiences a seasonal increase in tips, and that the user is searching for a job at the beginning of the season. For example, if the average tip data for the preceding six months is 15 dollars per table, tip data analysis engine 510 could understand that preceding six month were for fall and winter. By analyzing transaction data for restaurants in that area, tip data analysis engine 510 could be determined that the restaurants in that area experience a 33 percent increase in tips in the spring and summer and predict that the tips will average 20 dollars per table.

Additionally, where a browser extension has determined that a user is visiting indeed.com, indeed.com is on the whitelist, and the job posting is for a merchant that does not have a merchant record in the database, tip data analysis engine 510 may use additional information provided by the browser extension to predict tip data. For example, if the browser extension determines that user is searching from a location in Washington, D.C., tip data analysis engine 510 may analyze transactions for restaurants located in Washington, D.C. to predict a tip average of 20 dollars per table in that area. Similarly, if restaurant does not have a merchant record in the database, tip data analysis engine 510 may use the location information of the restaurant identified in the job posting to identify and analyze transactions for restaurants in and around that location. Tip data analysis engine 510 also may use the restaurant type to understand which types of restaurant jobs the user may be interested in and analyze transaction for those types of restaurants in that area to predict tip data.

Client device 508 can include a browser interacting with websites, for example, a tip tracker 536 that includes tip data from the server 506. For example, tip tracker 536 can include a map 538 of various restaurant locations having tip data. Tip tracker 536 can include a list 540 of various restaurants and an indication of tips. For example, tips may be scored on a scale of 1 to n where 1 is a low tip and n is a high tip. The tip data can be displayed as a number of dollar signs such as n=4 with a display of one ($), two ($$), three ($$$), or four ($$$$) dollar signs. List 540 displays tip data using dollar signs for six restaurants in a geographical area with their locations indicated on map 538.

System 500 can improve the availability of tip data, which is currently an opaque data source and not available to most people. When a restaurant worker is considering a new job, the worker probably doesn't know how much money they are going to make. System 500 can make tip data available to the service industry and help job seekers make good decisions with better information.

System 500 can analyze transactions and calculate tip data in various ways. For example, every day at a certain time, system 500 can run a job that analyzes all of the merchant data, all of the restaurant transaction data, and look at the difference between posted transactions and authorized transactions. This can entail analyzing tens of millions of transactions on a daily basis. This analysis can be performed on a per merchant basis (e.g., with reference to transactions involving a particular merchant or group of merchants), on a geographic basis (e.g., with reference to transactions involving merchants within a region or geographic area), on a time basis (e.g., with reference to transactions occurring within a time period), on demand (e.g., on an as-requested with a customized parameters) and any combination thereof. By changing the configuration of the analysis, the number of transactions to be analyzed can be reduced.

The workload can begin when a user is on the merchant's website or on a job listing site and the browser extension has determined that the user searching for a job at this particular merchant. For example, the workload can begin when the browser extension has examined the contents of the website for key words such as waitress, server, restaurant, bartender and/or the like in combination with other indicators consistent with a job search engine to determine that a particular job posting is for a restaurant job and identified the name of the restaurant associated with the job posting. System 500 can perform this analysis in a hybrid way where a batch is performed on transactions once a month or some other frequency. System 500 can focus the analysis on the most popular kinds of transactions. For example, the middle 50% of merchants that are the most popular restaurants. Then, on demand, system 500 can refresh as needed when a user is on a particular site looking for a job.

System 500 can use artificial intelligence such as machine learning. For example, the system 500 can utilize various neural network, such as convolutional neural networks (“CNN”) or recurrent neural networks (“RNN”) to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (“LSTMs”) and gated recurrent units

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

A machine learning model can be used to determine that a user is starting to look for restaurant jobs. The browser extension on client device 508 can use an interface provided by server 506 to access the machine learning model. Once the browser extension on client device 508 determines that the user is starting to look for a restaurant job, the server 506 can determine the matching tip data for display on client device 508. For example, system 500 can determine that the user is looking for a job at merchant X or restaurant X. System 500 can analyze merchants that are similar to merchant X or restaurant X to determine the relevant tip data so that it would be a fast experience for the user. System 500 can perform a mix of regular batch jobs on certain merchants and then do specialized queries on similar merchants.

System 500 can use factors in the transaction data such as location data to limit the amount of transaction data to analyze and increase efficiency. Exemplary factors include, for example, location information such as merchant address and/or zip code, restaurant type (e.g., fast casual, upscale fine dining, pizza parlor, etc.), tip average ranges (e.g., >18% on average), and/or the like that may be used to limit the amount of transaction data to analyze and increase efficiency. If a user is looking for a job in Chicago, the tip data for restaurants in New York is probably not relevant because the user is probably not moving across state lines for restaurant jobs as frequently as they might for other jobs. Similarly, if a user is looking for a job at an upscale fine dining restaurant, fast casual and/or pizza parlors are likely not relevant to the analysis, whereas the tip average range may be. System 500 can use merchant similarity to increase efficiency by limiting the analysis to merchants with similar traits such as average price point or median price point averages. Client device 508 can include a histogram illustrating the trait such as the median price.

System 500 can analyze transaction data to bucket merchants into specific categories or types. For example, cafes, French restaurants, coffee shops, fast food, etc. System 500 can use the standard merchant category code in the transaction data to narrow the amount of transaction data to analyze. System 500 can use a merchant category code filter before determining tip data.

System 500 can maintain a list of restaurants and/or restaurant types known to have tip data in order to limit the amount of transaction data. For example, most sit-down restaurants tip servers but not all of them. By limiting the amount of transaction data to analyze, system 500 can be more efficient and not waste processing power.

System 500 can maintain database 504 to include a structured data store of merchants that fall within the merchant category codes for restaurants. SQL queries can be run to find lists of relevant restaurants and then transaction data for merchants at those restaurants can be analyzed. A random sampling of transactions can be taken to determine if the posted amount matched the authorization amount. By doing that, system 500 can glean which merchants are relevant without analyzing too much transaction data and using a sampling with a small data set. System 500 can figure out which merchants have tips and which do not. From there that data set with tip data can be referenced for the tip data analysis to figure out how much a tipped worker might get compensated at a particular restaurant.

System 500 can use a user trigger workflow. A browser extension can be installed on client device 508. The browser extension can determine that the user visits a job listing website based on a comparison of the uniform resource locator (URL) and a white list of job hunting websites. The browser extension can check a list of merchant's websites and detect if the user is on a jobs page on the merchant's website. This can be the beginning of the workflow. Once that happens, the browser extension can make an API call to server 506 to trigger the tip data analysis.

The server 506 can use location data to efficiently analyze transaction data. For example, client device 508 can determine the location of the user or the location in the job posting can be used. Server 506 can use fuzzy string detection logic to determine what the actual merchant record is based on texts from the website. Once server 506 finds the merchant record, then server 506 can check to see if the merchant is on the white list of merchants with tip data. If not, then the workflow ends. If it is, then server 506 can pull the latest tip data. The tip data can be broken down in various ways. Tip data can be broken down by time of day, by day of the week, by seasonality, etc. Server 506 can retrieve tip data and display it broken down in various ways on client device 508. Server 506 can do merchant similarity analysis and proactively pull tip data for restaurants that are nearby in certain types of categories. Server 506 can pull tip data so that as the user continues to browse, the browser extension can pop-up tip data very quickly. Client device 508 can show the user a display that suggest other restaurants that are similar and in the same zip code, for example and provide tip data for the similar restaurants as well.

In addition to using a white list, system 500 can use a black list of places that do not have tip data. If a restaurant is on the black list, then the workflow can end. Just because a restaurant is not on the white list doesn't mean that there are no tips there as in the example of a new restaurant. Client device 508 can display a notice that a restaurant is a non-tip restaurant because it is on the black list and describe approximately how much the user would make and how it would compare to tipping restaurants. If a particular restaurant is not on the blacklist and is not a known merchant, then system 500 can analyze how much people tip at that restaurant.

Server 506 can include a number of API calls available to the browser extension running on client device 508. The API calls can access information in database 504 and a machine learning model. The machine learning model can be hosted on a cloud platform or data center. The machine learning model can be used to predict that the user is looking for a restaurant job based on activity in the browser on client device 508.

Server 506 can limit the transaction data to be analyzed by determining whether the type of job the user is looking for is a tipped position. For example, dishwashers, busboys, servers, bartenders, and general managers may or may not be tipped positions. Server 506 can filter, segment, and focus on limited transaction data to efficiently analyze tip data. Server 506 can include a micro service based on prior analysis taking into account various factors such as restaurant type, job, location, and so on. For example, data can be limited to the top number of cities or top number of metropolitan areas or locations where most of the customers having transaction data live.

FIG. 6 depicts an example Point of Sale (PoS) device 600 according to an example embodiment of the disclosure. PoS device 600 may provide the interface at what a customer or end user makes a payment to the merchant in exchange for goods or services. PoS device 600 may include and/or cooperate with weighing scales, scanners, electronic and manual cash registers, electronic funds transfer at point of sale (EFTPOS) terminals, touch screens and any other wide variety of hardware and software available for use with PoS device 600. PoS device 600 may be a retail point of sale system and may include a cash register and/or cash register-like computer components to enable purchase transactions. PoS device 600 also may be a hospitality point of sale system and include computerized systems incorporating registers, computers and peripheral equipment, usually on a computer network to be used in restaurant, hair salons, hotels or the like. PoS device 600 may be a wireless point of sale device similar to a PoS device described herein or, for example a tablet computer that is configured to operate as a PoS device, including for example, software to cause the tablet computer to execute point of sale functionality and a card reader such as for example the Capital One® SparkPay card reader, the Square® reader, Intuit's® GoPayment reader, or the like. PoS device 600 also may be a cloud-based point of sale system that can be deployed as software as a service, which can be accessed directly from the Internet using, for example, an Internet browser.

Referring to FIG. 6, an example PoS device 600 is shown. PoS device 600 may include a controller 602, a reader interface 604, a data interface 606, a smartcard reader 608, a magnetic stripe reader 610, a near-field communications (NFC) reader 612, a power manager 614, a keypad 616, an audio interface 618, a touchscreen/display controller 620, and a display 622. Also, PoS device 600 may be coupled with, integrated into or otherwise connected with a cash register/retail enterprise system 624.

In various embodiments, Controller 602 may be any controller or processor capable of controlling the operations of PoS device 600. For example, controller 602 may be an Intel® 2nd Generation Core™ i3 or i5 or Pentium™ G850 processor or the like. Controller 602 also may be a controller included in a personal computer, smartphone device, tablet PC or the like.

Reader interface 604 may provide an interface between the various reader devices associated with PoS device 600 and PoS device 600. For example, reader interface 604 may provide an interface between smartcard reader 608, magnetic stripe reader 610, NFC reader 612 and controller 602. In various embodiments, reader interface 604 may be a wired interface such as a USB, RS232 or RS485 interface and the like. Reader interface 604 also may be a wireless interface and implement technologies such as Bluetooth, the 802.11(x) wireless specifications and the like. Reader interface 604 may enable communication of information read by the various reader devices from the various reader devices to PoS device 600 to enable transactions. For example, reader interface 604 may enable communication of a credit or debit card number read by a reader device from that device to PoS device 600. In various embodiments, reader interface 604 may interface between PoS device 600 and other devices that do not necessarily “read” information but instead receive information from other devices.

Data interface 606 may allow PoS device 600 to pass communicate data throughout PoS device and with other devices including, for example, cash register/retail enterprise system 624. Data interface 606 may enable PoS device 600 to integrate with various customer resource management (CRM) and/or enterprise resource management (ERP) systems. Data interface 606 may include hardware, firmware and software that make aspects of data interface 606 a wired interface. Data interface 606 also may include hardware, firmware and software that make aspects of data interface 606 a wireless interface. In various embodiments, data interface 606 also enables communication between PoS device other devices.

Smartcard reader 608 may be any electronic data input device that reads data from a smart card. Smartcard reader 608 may be capable of supplying an integrated circuit on the smart card with electricity and communicating with the smart card via protocols, thereby enabling read and write functions. In various embodiments, smartcard reader 608 may enable reading from contact or contactless smart cards. Smartcard reader 608 also may communicate using standard protocols including ISO/IEC 7816, ISO/IEC 14443 and/or the like or proprietary protocols.

Magnetic stripe reader 610 may be any electronic data input device that reads data from a magnetic stripe on a credit or debit card, for example. In various embodiments, magnetic stripe reader 610 may include a magnetic reading head capable of reading information from a magnetic stripe. Magnetic stripe reader 610 may be capable of reading, for example, cardholder information from tracks 1, 2, and 3 on magnetic cards. In various embodiments, track 1 may be written on a card with code known as DEC SIXBIT plus odd parity and the information on track 1 may be contained in several formats (e.g., format A, which may be reserved for proprietary use of the card issuer; format B; format C-M which may be reserved for us by ANSI subcommittee X3B10; and format N-Z, which may be available for use by individual card issuers). In various embodiments, track 2 may be written with a 5-bit scheme (4 data bits plus 1 parity). Track 3 may be unused on the magnetic stripe.

NFC reader 612 may be any electronic data input device that reads data from a NFC device. In an exemplary embodiment, NFC reader 612 may enable Industry Standard NFC Payment Transmission. For example, the NFC reader 612 may communicate with a NFC enabled device to enable two loop antennas to form an air-core transformer when placed near one another by using magnetic induction. NFC reader 612 may operate at 13.56 MHz or any other acceptable frequency. Also, NFC reader 612 may enable a passive communication mode, where an initiator device provides a carrier field, permitting answers by the target device via modulation of existing fields. Additionally, NFC reader 612 also may enable an active communication mode by allowing alternate field generation by the initiator and target devices.

In various embodiments, NFC reader 612 may deactivate an RF field while awaiting data. NFC reader 612 may receive communications containing Miller-type coding with varying modulations, including 100% modulation. NFC reader 612 also may receive communications containing Manchester coding with varying modulations, including a modulation ratio of approximately 10%, for example. Additionally, NFC reader 612 may be capable of receiving and transmitting data at the same time, as well as checking for potential collisions when the transmitted signal and received signal frequencies differ.

NFC reader 612 may be capable of utilizing standardized transmission protocols, for example but not by way of limitation, ISO/IEC 14443 A/B, ISO/IEC 18092, MiFare, FeliCa, tag/smartcard emulation, and the like. Also, NFC reader 612 may be able to utilize transmission protocols and methods that are developed in the future using other frequencies or modes of transmission. NFC reader 612 also may be backwards-compatible with existing payment techniques, such as, for example RFID. Also, NFC reader 612 may support transmission requirements to meet new and evolving payment standards including internet based transmission triggered by NFC. In various embodiments, NFC reader 612 may utilize MasterCard® PayPass and/or Visa® PayWave and/or American Express® ExpressPay systems to enable transactions.

Although not shown and described, other input devices and/or readers, such as for example, barcode readers and the like are contemplated.

Power manager 614 may be any microcontroller or integrated circuit that governs power functions of PoS device 600. Power manager 614 may include, for example, firmware, software, memory, a CPU, a CPU, input/output functions, timers to measure intervals of time, as well as analog to digital converters to measure the voltages of the main battery or power source of PoS device 600. In various embodiments, Power manager 614 remain active even when PoS device 600 is completely shut down, unused, and/or powered by the backup battery. Power manager 614 may be responsible for coordinating many functions, including, for example, monitoring power connections and battery charges, charging batteries when necessary, controlling power to other integrated circuits within PoS device 600 and/or other peripherals and/or readers, shutting down unnecessary system components when they are left idle, controlling sleep and power functions (on and off), managing the interface for built-in keypad and trackpads, and/or regulating a real-time clock (RTC).

Keypad 616 may any input device that includes a set of buttons arranged, for example, in a block or pad and may bear digits, symbols and/or alphabetical letters. Keypad 616 may be a hardware-based or mechanical-type keypad and/or implemented in software and displayed on, for example, a screen or touch screen to form a keypad. Keypad 616 may receive input from a user that pushed or otherwise activates one or more buttons on keypad 616 to provide input.

Audio interface 618 may be any device capable of providing audio signals from PoS device 600. For example, audio interface may be a speaker or speakers that may produce audio signals. In various embodiments, audio interface 618 may be integrated within PoS device 600. Audio interface 618 also may include components that are external to PoS device 600.

Touchscreen/display control 620 may be any device or controller that controls an electronic visual display. Touchscreen/display control 620 may allow a user to interact with PoS device 600 through simple or multi-touch gestures by touching a screen or display (e.g., display 622). Touchscreen/display control 620 may be configured to control any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, touchscreen/display control 620 may receive inputs from the touchscreen and process the received inputs. Touchscreen/display control 620 also may control the display on PoS device 600, thereby providing the graphical user interface on a display to a user of PoS device 600.

Display 622 may be any display suitable for a PoS device. For example, display 622 may be a TFT, LCD, LED or other display. Display 622 also may be a touchscreen display that for example allows a user to interact with PoS device 600 through simple or multi-touch gestures by touching a screen or display (e.g., display 622). Display 622 may include any number of touchscreens, including, for example, resistive touchscreens, surface acoustic wave touchscreens, capacitive touchscreens, surface capacitance touchscreens, projected capacitance touchscreens, mutual capacitance touchscreens, self-capacitance touchscreens, infrared grid touchscreens, infrared acrylic projection touchscreens, optical touchscreens, touchscreens based on dispersive signal technology, acoustic pulse recognition touchscreens, and the like. In various embodiments, 622 may receive inputs from control gestures provided by a user. Display 622 also may display images, thereby providing the graphical user interface to a user of PoS device 600.

Cash register/retail enterprise system 624 may me any device or devices that cooperate with PoS device 600 to process transactions. Cash register/retail enterprise system 624 may be coupled with other components of PoS device 600 via, for example, a data interface (e.g., data interface 606) as illustrated in FIG. 6. Cash register/retail enterprise system 624 also may be integrated into PoS device 600.

In various embodiments, cash register/retail enterprise system 624 may be a cash register. Example cash registers may include, for example, mechanical or electronic devices that calculate and record sales transactions. Cash registers also may include a cash drawer for storing cash and may be capable of printing receipts. Cash registers also may be connected to a network to enable payment transactions. Cash registers may include a numerical pad, QWERTY or custom keyboard, touch screen interface, or a combination of these input methods for a cashier to enter products and fees by hand and access information necessary to complete the sale.

In various embodiments, cash register/retail enterprise system 624 may comprise a retail enterprise system and/or a customer relationship management system. Retail enterprise system 624 may enable retain enterprises to manage operations and performance across a retail operation. Retail enterprise system 624 may be a stand-alone application in, for example, individual stores, or may be interconnected via a network. Retail enterprise system 624 may include various point of sale capabilities, including the ability to, for example, customize and resize transaction screens, work with a “touch screen” graphical user interface, enter line items, automatically look up price (sales, quantity discount, promotional, price levels), automatically compute tax, VAT, look up quantity and item attribute, display item picture, extended description, and sub-descriptions, establish default shipping services, select shipping carrier and calculate shipping charges by weight/value, support multi-tender transactions, including cash, check, credit card, and debit card, accept food stamps, place transactions on hold and recall, perform voids and returns at POS, access online credit card authorizations and capture electronic signatures, integrate debit and credit card processing, ensure optional credit card discounts with address verification, support mix-and-match pricing structure, discount entire sale or selected items at time of sale, add customer account, track customer information, including total sales, number of visits, and last visit date. issue store credit, receive payment(s) for individual invoices, process deposits on orders, search by customer's ship-to address, create and process layaway, back orders, work orders, and sales quotes, credit items sold to selected sales reps, view daily sales graph at the PoS, view and print journals from any register, preview, search, and print journals by register, batch, and/or receipt number, print X, Z, and ZZ reports, print receipts, invoices, and pick tickets with logos/graphics, print kit components on receipt, reprint receipts, enter employee hours with an integrated time clock function, and/or sell when the network/server is down with an offline PoS mode. Retail enterprise system 624 also may include inventory control and tracking capabilities, reporting tools, customer management capabilities, employee management tools, and may integrate with other accounting software.

In various embodiments cash register/retail enterprise system 624 may be a hospitality PoS. In such embodiments, retail enterprise system 624 may include hospitality PoS software (e.g., Aloha PoS Restaurant software from NCR®, Micros® RES and Symphony software and the like), hospitality management software, and other hardware and software to facilitate hospitality operations.

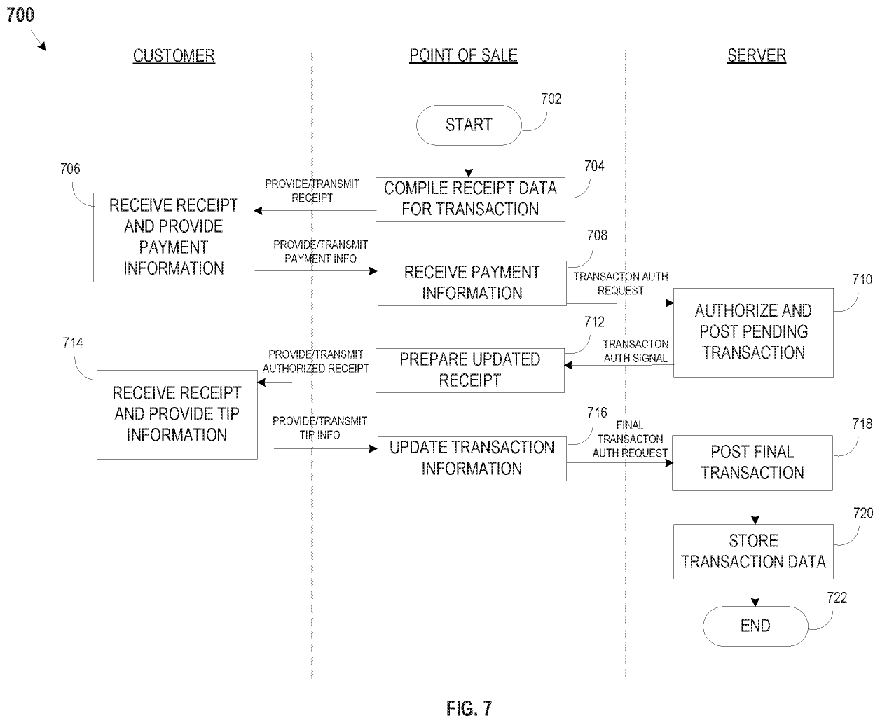

FIG. 7 is a flow chart of an example method 700 that illustrates example interactions between some of the system components according to an example embodiment of the disclosure. As show in FIG. 7, the example system components can include a customer, including a customer device, a point of sale, including a point of sale device, and a server. Customer device may be similar to the client device (e.g., client device 102 and/or client device 508) as shown and described herein. The point of sale device may be similar to the point of sale device as shown and described herein, for example, with respect to FIGS. 5 and 6. The server may be similar to the server as shown and described herein (e.g., server 104 and/or server 506).

Method 700 may begin at block 702. In block 704, a point of sale system may compile receipt data for a transaction. For example, a waitress, server, bartender, or the like may enter the customer's order information into a point of sale system. The customer, using a customer device also may input his or her order into the client device and transmit the order information to the point of sale device. When the customer's order is complete, the point of sale system may compile the receipt data and calculate an amount owed, including tax and service charges to be applied to the order. This amount indicates the pre-tip amount owed for the order. The point of system may then transmit and/or provide the receipt to the customer. For example, the point of sale may print the receipt for the server to provide to the customer. The point of sale also may transmit the receipt electronically to the customer via, for example, a mobile application on the customer device that is in communication with the point of sale system.

In block 706, the customer may receive the receipt, including the pre-tip amount owed, in person from the server and/or electronically via a customer device. The customer may provide payment information to the point of sale system. For example, the customer may provide a payment card (e.g., a credit or debit card or the like) to the server, where the server will then provide the payment card information to the point of sale system. The customer also may provide payment card information via his or her customer device, which may be transmitted from the mobile device to the point of sale system. For example, using a mobile application associated with the restaurant and/or the point of sale system, the customer may view the receipt and provide payment information that may be stored in, for example, a mobile wallet to the point of sale system. In one example, the customer may use ApplePay or the like to provide payment information. The customer also may use a mobile application associated with a financial institution, for example, that interacts with the restaurant mobile application to receive payment information to be transmitted to the point of sale system. The customer also may input payment information directly into the mobile application associated with the restaurant and/or point of sale system to be transmitted to the point of sale system. The customer also may select payment information that is “on file” and stored in the mobile application associated with the restaurant and/or point of sale system, which then may be retrieved and transmitted to the point of sale system.

In block 708, the point of sale system may receive payment information. For example, the server may swipe or dip a payment card to provide the payment information to the point of sale system. The point of sale system also may receive the payment information electronically via a communication network. The point of sale system may use this payment information to generate a transaction authorization request.

In block 710, the server may facilitate the authorization and posting of a transaction. For example, to authorize and post a transaction, merchants, cardholders and financial institutions may be connected with a card association network to enable secure transactions and timely payments. In various embodiments, processing a payment card transaction may involve two stages: (1) authorization and (2) clearing and settlement. Authorization may refer to an electronic request that is sent through various parties to either approve or decline the transaction. Clearing and Settlement may refer to settlement of the parties' settle accounts to enable the parties to get paid.

During authorization, when the customer provides payment information to the point of sale system, the point of sale system may submit a payment transaction to a payment gateway on behalf of the customer via secure connection from a Web site, retail location, or a wireless device. In various embodiments, the point of sale system may submit a payment transaction to a payment gateway on behalf of the customer via the server.

The payment gateway may receive the secure transaction information and may pass the secure transaction information via a secure connection to the merchant acquirer's front-end processor. The merchant acquirer's front-end processor may submit the transaction to and association/interchange (e.g., a network of financial entities that communicate to manage the processing, clearing and settlement of credit card transactions). The association/interchange may route the transaction to the customer's Issuer. The Issuer may approve or decline the transaction and pass the transaction results back through association/interchange. The association/interchange then may relay the transaction results to the merchant acquirer's front-end processor.

The merchant acquirer's front-end processor may relay the transaction results back to the payment gateway and/or terminal. The payment gateway may store the transaction results and send them to the merchant and/or server. The merchant may receive the authorization response and complete the transaction accordingly.

During settlement, the merchant may deposit the transaction receipt with acquirer via, for example, a settlement batch. Captured authorizations may be passed from the merchant acquirer's front-end processor to the merchant acquirer's back-end processor for settlement. The merchant acquirer's back-end processor may generate ACH files for merchant settlement. The acquirer may submit settlement files to the Issuer for reimbursement via association/interchange. The Issuer may post the transaction and pay merchant.

In block 710, when the transaction is authorized, the server may receive authorization information and post the transaction to the customer's account. The server may transmit an authorization signal to the point of sale system.

In block 712, the point of sale system may prepare an updated receipt. The updated receipt may include the pre-tip amount and a request for a tip. For example, if the updated receipt is a printed receipt, the printed receipt may include lines for the customer to write in a tip. If the updated receipt is an electronic receipt that is electronically transmitted to a customer device, the updated receipt may include an interface that allows the customer to select a tip and/or input tip information via the interface. The updated receipt may be provided and/or transmitted to the customer accordingly.

In block 714, the customer may receive the updated receipt and provide tip information. For example, if the updated receipt is a printed receipt, the customer may write in a tip and sign the receipt where appropriate. If the updated receipt is an electronic receipt that is electronically transmitted to a customer device, the customer may input tip information via the interface. The tip information may be provided and/or transmitted to the customer accordingly.

In block 716, the point of sale system may update the transaction information so that the total transaction amount, including the tip information for example, may be authorized. In various embodiments, the point of sale system may store the tip information electronically and/or provide the stored tip information to the server. For example, the point of sale system may store the tip information as an absolute amount of the transaction (e.g., $20 tip on $100 order) and/or as a percentage (e.g., 20%). The point of sale system may then request that the updated transaction, including the tip information be authorized.

In block 718, the server may receive information related to the updated transaction, facilitate authorization of the updated transaction in a manner similar to as described above in block 710. The server may post the final transaction, including the updated transaction.

In block 720, the server may store the transaction data in a manner shown and described herein to enable the server to apply artificial intelligence to the transaction data and provide reliable tip information to a job seeker seeking, for example, a job at a particular restaurant. Method 700 may end at block 722.

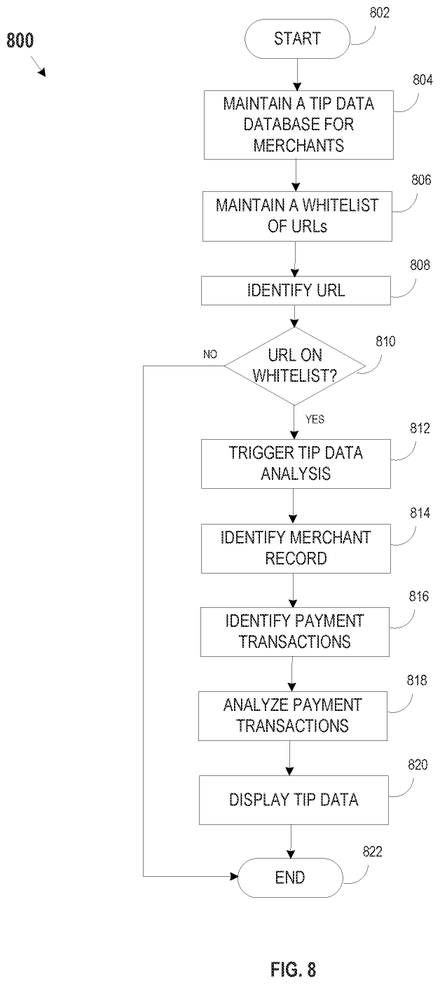

FIG. 8 is flow chart of a method 800 according to an example embodiment of the disclosure. Method 800 may begin at block 802. In block 804, a tip data database may be maintained for one or more merchants. The tip data database may be maintained in a manner similar to as shown and described with respect to the tip data table (e.g., tip data table 116) and database (e.g., database 504). For example, a database can a store tip data table that is indexed by restaurant and has tip data for each indexed restaurant. The database also may store additional information for each indexed restaurant, including but not limited to, for example, restaurant location information, a restaurant type, and other unique information associate with the restaurant.

In block 806, a whitelist of job posting websites may be maintained. For example, a browser extension (e.g., browser extension 110), one or more interfaces (e.g., tip data interface 112, 404, and/or restaurant matching interface 114, 406) and/or a server (e.g., server 104 and/or server 506) may maintain a whitelist of job posting websites including, but not limited to Ihirehopsitality.com, Culinaryagents.com, LinkedIn.com, Ziprecruiter.com, Careerbuilder.com, Launch.com, Indeed.com, Restaurantjobs.com and the like. The whitelist also may identify restaurants for which tip data is maintained in the database. In this way, the whitelist may indicate that there is tip data to be analyzed using artificial intelligence, for example. The tip data may exist for the particular restaurant(s) associated with user searches and/or nearby or similar restaurants. The existence of tip data may trigger tip data analysis as explained in further detail below.

In block 808, a URL may be identified. For example, when a user visits a particular website, the browser extension may determine the URL associated with that website. In this way, the browser extension may become aware that the user is visiting, for example, a job posting website, which may trigger tip data analysis as explained in further detail below.

In block 810, it may be determined if the URL is on the whitelist. For example, the browser extension and/or server may compare the identified URL to the URLs in the whitelist. If there is a match, method 800 may proceed to block 812. If there is not a match, method 800 may end at block 822.

In block 812, tip data analysis may be triggered. Understanding that the user is visiting a job posting website, the browser extension, for example, may trigger tip data analysis using artificial intelligence machine learning to analyze the data, make certain assumptions, learn and provide predictions related to tip data. For example, as explained in further detail herein, transaction data may be analyzed using artificial intelligence machine learning to predict tip data for a particular website that is the subject of a job posting. Transaction data also may be analyzed using artificial intelligence machine learning to predict tip data for a particular area where the user is located and/or the location of a restaurant that is the subject of a particular search.

In block 814, a merchant record may be identified. Where, for example, a browser extension has determined that a user is searching for a job on a job posting website, the browser extension may provide information about the merchant to be used to identify a merchant record in a database. For example, if a user is searching for a server job on indeed.com and is viewing a job posting for a server job at the Outback Steakhouse, the browser extension may provide information identifying the Outback Steakhouse, including but not limited to the name, location and/or other unique identifying information to enable the server, for example, to identify a merchant record in a database for the Outback Steakhouse. If there is a record for the Outback Steakhouse in the database, as explained in more detail herein, payment transactions for the Outback Steakhouse, alone or in combination with other data, may be analyzed using artificial intelligence machine learning to predict tip data. If there is not a record for the Outback Steakhouse in the database, as explained in more detail herein, other transaction data in the database may be analyzed using artificial intelligence machine learning to predict tip data.

In block 818, transaction data may be analyzed using artificial intelligence machine learning to predict tip data. For example, where a browser extension has determined that a user is visiting indeed.com, indeed.com is on the whitelist, and the job posting is for Outback Steakhouse store number 12345, the transaction data associated with Outback Steakhouse store number 12345, may be analyzed using artificial intelligence machine learning to predict that the tips for the next six months will average 20 dollars/per table. This analysis may include the average tips based on the transaction data herein. The analysis also may include, for example, understanding that the particular Outback Steakhouse is located in an area that experiences a seasonal increase in tips, and that the user is searching for a job at the beginning of the season. For example, if the average tip data for the preceding six months is 15 dollars per table, the analysis could understand that preceding six month were for fall and winter. But by analyzing transaction data for restaurants in that area, it could be determined that the restaurants in that area experience a 33 percent increase in tips in the spring and summer and predict that the tips will average 20 dollars per table.

Additionally, where a browser extension has determined that a user is visiting indeed.com, indeed.com is on the whitelist, and the job posting is for a merchant that does not have a merchant record in the database, additional information provided by the browser extension may be analyzed using artificial intelligence machine learning to predict tip data. For example, if the browser extension determines that user is searching from a location in Washington, DC, transactions for restaurants located in Washington, D.C. may be analyzed to predict a tip average of 20 dollars per table in that area. Similarly, if restaurant does not have a merchant record in the database, the location information of the restaurant identified in the job posting may be used to identify and analyze transactions for restaurants in and around that location. The restaurant type also may be used to understand which types of restaurant jobs the user may be interested in and analyze transaction for those types of restaurants in that area to predict tip data.

In block 820, the tip data may be displayed to the user similar to as shown and described herein. Method 800 may end at block 822.

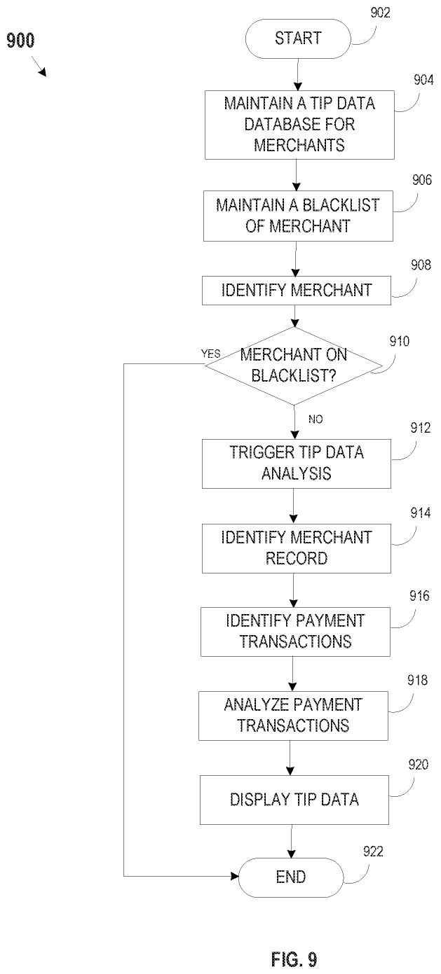

FIG. 9 is flow chart of a method 900 according to an example embodiment of the disclosure. Method 900 may begin at block 902. In block 904, a tip data database may be maintained in a manner similar to as shown and described in block 804 of FIG. 8.

In block 906, a blacklist of merchants may be maintained. For example, a browser extension (e.g., browser extension 110), one or more interfaces (e.g., tip data interface 112, 404, and/or restaurant matching interface 114, 406), and/or a server (e.g., server 104 and/or server 506) may maintain a blacklist of merchants that do not appear in the database and/or tip data table. The blacklist may identify particular merchants and/or groups of merchants for which there is/are no tip data available for analysis. The blacklist may identify merchants by name, location, restaurant type, and/or the like, which may be used to determine whether data exists in the database for a particular merchant and/or set of merchants.

In block 908, a merchant record may be identified. A browser extension may, for example, examine the contents of the job posting and/or website and determine a merchant identify from the contents. The browser extension also may monitor user searches to determine a merchant identity from the website. When identifying information is obtained, the identifying information may be cleansed by the browser extension and/or server to identify the merchant.

In block 910, it may be determined if the merchant is on the blacklist. For example, the browser extension and/or server may compare the identified merchant to the merchants in the blacklist. The browser extension and/or server also may compare other information about merchants to information on the blacklist. For example, if the restaurant has a particular type, the restaurant type may be compared against the blacklist to understand whether there are any restaurants having the same type on the blacklist. Location information also may be used to be compared against information on the blacklist. If there is a not a match (i.e., the information is not on the blacklist), method 900 may proceed to block 912. If there is a match (i.e., the information is on the blacklist), method 900 may end at block 922.

In block 912, tip data analysis may be triggered in a manner that is similar as shown and described in block 812 of FIG. 8.

In block 914, a merchant record may be identified in a manner that is similar as shown and described in block 814 of FIG. 8.

In block 916, payment transactions may be identified in a manner that is similar as shown and described in block 816 of FIG. 8.

In block 918, the transactions may be analyzed in a manner that is similar as shown and described in block 818 of FIG. 8.

In block 920, tip data may be displayed in a manner that is similar as shown and described in block 820 of FIG. 8. Method 900 may end in block 922.

In this description, numerous specific details have been set forth. It is to be understood, however, that implementations of the disclosed technology can be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described can include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it could.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a merchant matching interface that is configured to receive website information from a browser extension, determine whether the received website information identifies a merchant, identify an indexed merchant in a database based on the determination that the received website information identifies a merchant, and use other website information to identify one or more indexed merchants based on a determination that the received web site information does not identify a merchant; and
a tip data analysis engine that is configured to use a machine learning model to analyze the tip data associated with one or more indexed merchants in the database based on the received identification information, wherein:
the browser extension is configured to examine contents of a website and determine that the internet browser is presenting a website that includes a job posting,
the browser extension is configured to extract the website information and transmit the website information to the merchant matching interface, and
the browser extension is configured to receive tip data from the tip data analysis engine and display the tip data to a user via the internet browser.

2. The system of claim 1, further comprising:
a database that stores the tip data, is indexed by merchant, and has tip data and other merchant identifying information for each indexed merchant; and
a tip data interface that is configured to receive identification information from the merchant matching interface and retrieve tip data associated with one or more indexed merchants in the database based on the received identification information.

3. The system of claim 1, wherein the tip data analysis engine is trained to determine tip data based on information received from a browser extension.

4. The system of claim 1, wherein the browser extension includes a browser extension application programming interface (API) that enables the browser extension to access the website data and user interface items and read the website data and user interface items.

5. The system of claim 1, wherein the browser extension is further configured to maintain a whitelist of websites that include job postings to enable the determination that the internet browser is presenting a website that includes a job posting.

6. The system of claim 1, wherein the merchant matching interface is further configured to maintain a blacklist that identifies merchants that are not indexed in the database to indicate that other website information is to be used to identify one or more indexed merchants.

7. The system of claim 1, wherein the tip data analysis engine further configured to calculate tip data using a first transaction that does not include tip data and a second transaction that does include tip data.

8. The system of claim 1, wherein the tip data analysis engine further configured to calculate tip data using a plurality of transactions associated with one or more indexed merchants.

9. A method, comprising:
reading, using a browser extension, internet website content associated with an internet web site;
determining, using the browser extension and the read website content, that the internet website includes a job posting;
extracting, using the browser extension, merchant information from the read website content;
transmitting, via a network, merchant information to a tip data analysis engine;
receiving, via the network, tip data from the tip data analysis engine; and
displaying, via a graphical user interface and using the browser extension, the received tip data, wherein a merchant matching interface is configured to:
receive the merchant information from the browser extension,
determine whether the received website information identifies a merchant,
identify an indexed merchant in a database based on the determination that the received website information identifies a merchant, and
use other merchant information to identify one or more indexed merchants based on a determination that the received website information does not identify a merchant, and
wherein the tip data analysis engine is configured to use a machine learning model to analyze the tip data associated with one or more indexed merchants in the database based on the received identification information.

10. The method of claim 9, wherein the browser extension includes a browser extension application programming interface (API) that enables the browser extension to access the website content and user interface items and read the website content and user interface items.

11. The method of claim 9, further comprising:
maintaining, by the browser extension, a whitelist of websites that include job postings; and
determining, by the browser extension, that the internet browser is presenting a website that includes a job posting.

12. The method of claim 9, wherein the merchant matching interface is further configured to maintain a blacklist that identifies merchants that are not indexed in the database to indicate that other website information is to be used to identify one or more indexed merchants.

13. The method of claim 9, wherein the tip data analysis engine further configured to calculate tip data using a plurality of transactions associated with one or more indexed merchants.

14. The method of claim 9, further comprising providing a tip data interface is configured to receive identification information from the merchant matching interface and retrieve tip data associated with one or more indexed merchants in the database based on the received identification information.

15. A non-transitory computer-accessible medium having stored thereon computer-executable instructions, wherein upon execution by a computer arrangement comprising a processor, the instructions cause the computer arrangement to perform procedures, comprising:
providing a restaurant matching interface that is configured to receive website information from a browser extension, determine whether the received website information identifies a restaurant, identify an indexed restaurant in a database based on the determination that the received website information identifies a restaurant, and use other website information to identify one or more indexed restaurant based on a determination that the received web site information does not identify a restaurant; and
providing a tip data analysis engine that is configured to use a machine learning model to analyze the tip data associated with one or more indexed restaurants in the database based on the received identification information.

16. The non-transitory computer-accessible medium of claim 15, wherein:
the browser extension is configured to examine contents of a website and determine that the internet browser is presenting a website that includes a job posting,
the browser extension is configured to extract the web site information and transmit the website information to the restaurant matching interface,
the browser extension is configured to receive tip data from the tip data analysis engine and display the tip data to a user via the internet browser, and
the browser extension is configured to maintain a whitelist of websites that include job postings to enable the determination that the internet browser is presenting a website that includes a job posting.

17. The non-transitory computer-accessible medium of claim 15, wherein the restaurant matching interface is further configured to maintain a blacklist that identifies restaurants that are not indexed in the database to indicate that other website information is to be used to identify one or more indexed restaurants.

18. The non-transitory computer-accessible medium of claim 15, further comprising providing a tip data interface that is configured to receive identification information from the restaurant matching interface and retrieve tip data associated with one or more indexed restaurants in the database based on the received identification information; and

19. The non-transitory computer-accessible medium of claim 15, wherein the tip data analysis engine further configured to calculate tip data using a first transaction that does not include tip data and a second transaction that does include tip data.

20. The non-transitory computer-accessible medium of claim 15, wherein the tip data analysis engine further configured to calculate tip data using a plurality of transactions associated with one or more indexed merchants.
